(19) United States
(12) Patent Application Publication
(10) Pub. No.: US 2026/0166952 A1
(43) Pub. Date: Jun. 18, 2026

(54) SYSTEMS AND METHODS FOR VEHICLE CONDITIONING

(71) Applicant: Ford Global Technologies, LLC, Dearborn, MI (US)

(72) Inventors: Mahmoud Yousef Ghannam, Canton, MI (US); Alan Gutowski, Wixom, MI (US); Robert Schroeter, Livonia, MI (US)

(73) Assignee: Ford Global Technologies, LLC, Dearborn, MI (US)

(21) Appl. No.: 18/981,591

(22) Filed: Dec. 15, 2024

(51) Int. Cl. B60H 1/00

(52) U.S. Cl. CPC B60H 1/00735; B60H 1/00585

(57) ABSTRACT

A smart system and methods for defogging surfaces of a vehicle are provided. The system uses external environment data and vehicle internal data to predict the probability of fogging in the vehicle. If the system determines that fogging is impending, the system then continually monitors the external environment data and the vehicle internal data to determine the onset and severity of the fogging as well as locations of where fogging will likely occur. Based on this information, the vehicle then activates one or more countermeasures to mitigate the fogging. The system uses a fogging function to model and determine the onset of fogging and a fogging severity function to determine the severity of the fogging. Once the severity of the fogging exceeds a first threshold, the system determines an appropriate countermeasure. This determined countermeasure is deployed or activated once the severity of the fogging exceeds a second threshold.

### FIELD

The present disclosure relates to the field of defogging in vehicles. Specifically, embodiments of the present disclosure relate to intelligent systems and methods for performing a defogging operation within a vehicle taking into account multiple types of internal and external environment data.

### BACKGROUND

Fogging inside a vehicle refers to the formation of condensation or mist on the interior surfaces of windows, usually the windshield and/or side windows. This phenomenon occurs when the temperature and humidity levels inside the vehicle differ significantly from those outside the vehicle, leading to the condensation of water vapor on the glass surfaces. The primary cause of fogging is the difference between the warm, moist air inside the vehicle and the cooler temperature of the glass surfaces. For example, when the weather is cold outside, but the cabin remains warm from the heater or passengers'breath, the moisture in the air condenses on the cooler glass, forming fog. This is particularly common in the winter months. The presence of humidity inside the car contributes to the process, with moisture sources including breathing, wet clothing, or snow and rain that are brought into the vehicle.

Another contributing factor to fogging is poor ventilation. When the vehicle's ventilation system is not functioning properly or when the air circulation is set to recirculate without introducing fresh air, the humidity level inside the vehicle rises, making fogging more likely. Additionally, poorly performing cabin air filters can reduce the effectiveness of the vehicle's defrosting or air conditioning system, which may also contribute to the issue. Excess moisture inside the car, such as from spilled drinks, wet mats, or damp clothing, can also exacerbate condensation.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an environment in which embodiments of the present disclosure can be implemented.

FIG. 2 illustrates a block diagram of a vehicle according to an embodiment of the present disclosure.

FIG. 3 illustrates a block diagram of a system according to an embodiment of the present disclosure.

FIG. 4 depicts a graph illustrating the effectiveness of the intelligent anti-fogging system according to an embodiment of the present disclosure.

FIG. 5 illustrates a flow chart of a process for mitigating the effects of fogging inside a vehicle according to an embodiment of the present disclosure.

FIG. 6 illustrates a flow chart of a process of an intelligent defogging feature according to another embodiment of the present disclosure.

FIG. 7 illustrates a block diagram of a server according to an embodiment of the present disclosure.

### DETAILED DESCRIPTION

### Overview

The present disclosure describes systems and methods for using vehicle external environment data and vehicle internal data to predict onset of fogging within the vehicle. The systems and methods further include predicting the severity of the fogging and taking appropriate countermeasure(s) to reduce/eliminate the fogging while also saving energy used by the vehicle.

Embodiments of the present disclosure provide a method for operating a vehicle. The method includes the vehicle determining one or more external conditions associated with an external environment of the vehicle and the vehicle determining vehicle internal data. The method further includes the vehicle determining, based on the one or more external conditions and the vehicle data, that fogging is impending. Thereafter, the method further includes the vehicle executing a first function to determine a severity of the fogging, followed by the vehicle determining that the severity of the fogging is above a threshold. Based on this determination, the method further includes the vehicle deploying one or more countermeasures.

In another instance, a method is provided that includes determining first data associated with one or more external conditions associated with an environment in the vicinity of a vehicle. The method further includes determining second data associated with the vehicle and determining, based on the first data and the second data, that fogging of one or more surfaces of the vehicle is impending. Thereafter, the method further includes determining a first severity of the fogging using a first function executing at a first rate and determining that the severity of fogging is above a first threshold. Based on this determination, the method further includes executing the first function at a second rate higher than the first rate and determining, using the first function executing at the second rate, a second severity of the fogging. Thereafter, the method includes determining that the second severity is at or above a second threshold and activating a countermeasure based on the second severity being at or above a second threshold.

In yet another instance, a vehicle is provided that includes one or more processors, one or more sensors coupled to the one or more processors, and a memory device coupled to the one or more processors. The memory device stores instructions, which when executed by the one or more processors cause the vehicle to perform several operations. The vehicle may determine first data associated with one or more external conditions associated with an environment in the vicinity of the vehicle and determine second data associated with the vehicle. Thereafter, the vehicle may determine, based on the first data and the second data, that fogging of one or more surfaces of the vehicle is impending. The vehicle may further determine, using a first function executing at a first rate, a first severity of the fogging and determine that the severity of fogging is above a first threshold. Then the vehicle may execute the first function at a second rate higher than the first rate and determine, using the first function executing at the second rate, a second severity of the fogging. Thereafter, the vehicle may determine that the second severity is at or above a second threshold and activate a countermeasure based on the second severity being at or above a second threshold.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

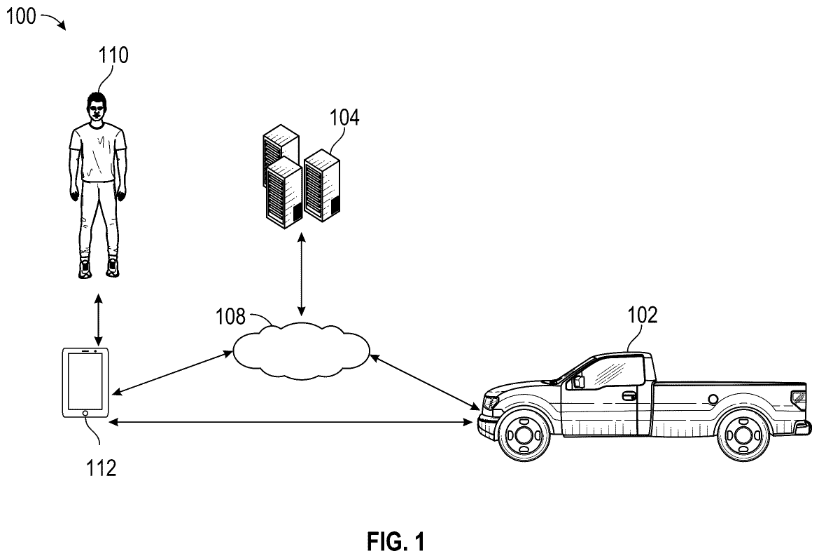

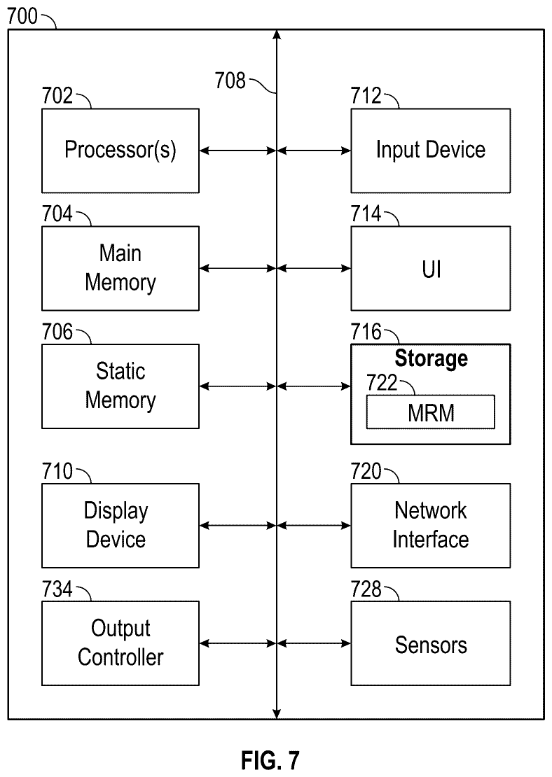

FIG. 1 illustrates an environment 100 in which the embodiments of the present disclosure may be implemented. The vehicle 102 can be any passenger or commercial vehicle such as a car, truck, tanker, bus, or the like. The environment 100 may also include a control server 104. The control server 104 may be part of a cloud-based computing infrastructure and may be associated with and/or include a Telematics Service Delivery Network (SDN) that provides digital data services to the vehicle 102. Details of the control server 104 are provided below with reference to FIG. 7.

The environment 100 may also include a user device 112. The user device 112 may be one of a mobile phone, a tablet, a personal computer, a smart key fob, or the like. The user device 112 may be associated with a user 110 of the vehicle 102. The user 110 may be a driver of the vehicle 102 or a passenger in the vehicle 102. The user device 112 may receive information from the vehicle 102 and/or the control server 104. The user device 112 may have a specialized application installed on it that can interface with the vehicle 102 to download and display various types of vehicle-generated information and other control data. In one embodiment, the vehicle 102 may directly communicate with the user device 112 to send and receive data without the need for the network 108 and/or the server 104.

The environment 100 may further include a network 108. The network 108 illustrates an example communication infrastructure in which the connected devices discussed in various embodiments of this disclosure may communicate. The network 108 may be and/or include the Internet, a private network, public network, or other configuration that operates using any one or more known communication protocols such as, for example, transmission control protocol/Internet protocol (TCP/IP), Bluetooth®, Bluetooth® Low Energy (BLE), Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

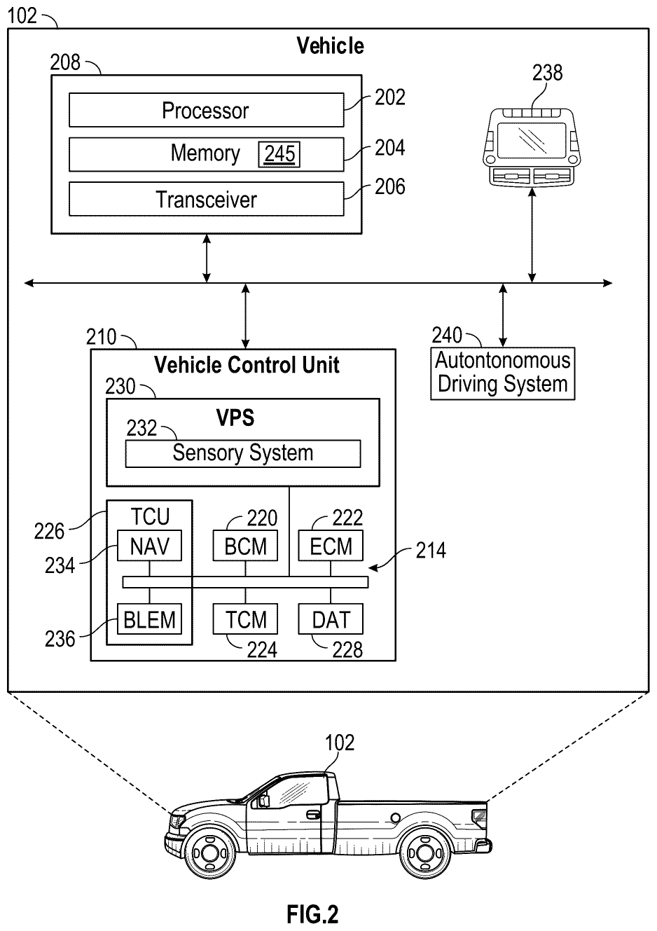

The vehicle 102 may include a plurality of units including, but not limited to, an automotive computer, a Vehicle Control Unit (VCU), and a detection unit. Details of the vehicle 102 are provided below in reference to FIG. 2.

FIG. 2 illustrates a block diagram of the vehicle 102 in which embodiments of the present disclosure can be implemented. The vehicle 102 may include a plurality of units including, but not limited to, an automotive computer 208, a Vehicle Control Unit (VCU) 210, and an infotainment unit 238. The VCU 210 may include a plurality of Electronic Control Units (ECUs) 214 disposed in communication with the automotive computer 208.

In some embodiments, a user device, such as a mobile phone, a laptop computer, a smart fob, or the like, may be configured to connect with the automotive computer 208, which may communicate via one or more wireless connection(s), and/or may connect with the vehicle 102 directly by using near field communication (NFC) protocols, Bluetooth® protocols, Wi-Fi, Ultra-Wideband (UWB), and other possible data connection and sharing techniques.

The automotive computer 208 may be installed anywhere in the vehicle 102, in accordance with the disclosure. The automotive computer 208 may be or include an electronic vehicle controller, having one or more processor(s) 202, one or more memory devices 204, and one or more transceivers 206.

The processor(s) 202 may be disposed in communication with one or more memory devices disposed in communication with the respective computing systems (e.g., the memory 204 and/or one or more external databases not shown in FIG. 2). The processor(s) 202 may utilize the memory 204 to store programs in code and/or to store data for performing operations in accordance with the disclosure. The memory 204 may be a non-transitory computer-readable storage medium or memory storing a vehicle control program code. The memory 204 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.). In some embodiments, memory 204 may include a module 245 that can implement the various embodiments of the present disclosure. Module 245 may include instructions that can be executed by the processor 202 to realize the various embodiments of the present disclosure.

Automotive computer 208 may also include a transceiver 206. The transceiver 206 may be configured to receive information/inputs from one or more external devices or systems, e.g., a user device 208, an external server, and/or the like. Further, the transceiver 206 may transmit notifications, requests, signals, etc., to the external devices or systems. In addition, the transceiver 206 may be configured to receive information/inputs from vehicle components such as the vehicle sensory system 232, one or more ECUs 214, and/or the like. Further, the transceiver 206 may transmit signals (e.g., command signals) or notifications to the vehicle components such as the BCM 220, the infotainment system 238, and/or the like.

In some embodiments, the VCU 210 may share a power and/or communications bus with the automotive computer 208 and may be configured and/or programmed to coordinate the data between vehicle systems, connected servers, and/or the like. The VCU 210 may include or communicate with any combination of the ECUs 214, such as, for example, the BCM 220, an Engine Control Module (ECM) 222, a Transmission Control Module (TCM) 224, a Telematics Control Unit (TCU) 226, a Driver Assistance Technologies (DAT) controller 228, etc. The VCU 210 may further include and/or communicate with a Vehicle Perception System (VPS) 230, having connectivity with and/or control of one or more vehicle sensory system(s) 232. The vehicle sensory system 232 may include one or more vehicle sensors including, but not limited to, a Radio Detection and Ranging (RADAR or “radar”) sensor configured for detection and localization of objects inside and outside the vehicle 102 using radio waves, sitting area buckle sensors, sitting area sensors, a Light Detecting and Ranging (“LIDAR”) sensor, door sensors, proximity sensors, temperature sensors, wheel sensors, one or more ambient weather or temperature sensors, vehicle interior and exterior cameras, steering wheel sensors, etc. The sensors that are part of the vehicle sensory system 232 may be coupled to the vehicle 102 at one or more locations and in one or more configurations. For example, the various sensors of the vehicle sensory system 232 may be integrated into the various subsystems of the vehicle 102, such as doors, mirrors, roof, etc. or attached to the vehicle 102 using an appropriate mounting mechanism. In some embodiments, the various sensors of the vehicle sensory system 232 may be located at the front, back, sides, top, bottom, and underneath the vehicle 102. The location of a sensor may depend on its function. For example, a sensor that monitors the area underneath the vehicle may be connected to a bottom surface of the vehicle 102, while a sensor that can monitor an area to any side of the vehicle 102 may be mounted or integrated into the doors of the vehicle 102. Vehicle sensory system 232 may also include one or more road noise sensors, such as accelerometers that are coupled to various mechanical components and/or systems of the vehicle 102. One skilled in the art will realize that the sensors may be coupled with the vehicle in various ways and locations other than the ones mentioned above.

In some embodiments, the VCU 210 may control vehicle operational aspects and implement one or more instruction sets received from the server 104, the user device 112, or from one or more instruction sets stored in the memory 204.

The TCU 226 may be configured and/or programmed to provide vehicle connectivity to wireless computing systems onboard and off board the vehicle 102, and may include a Navigation (NAV) receiver 234 for receiving and processing a GPS signal, a BLE® Module (BLEM) 236, a Wi-Fi transceiver, a UWB transceiver, and/or other wireless transceivers (not shown in FIG. 2) that may be configurable for wireless communication (including cellular communication) between the vehicle 102 and other systems (e.g., a vehicle key fob (not shown in FIG. 2), an external server, a user device, etc.), computers, and modules. The TCU 226 may be in communication with the ECUs 214 by way of a wired or wireless bus. In some aspects, the TCU 226 may be configured to determine a real-time vehicle geolocation, e.g., via the NAV receiver 234.

The ECUs 214 may control aspects of vehicle operation and communication using inputs from human drivers, inputs from the automotive computer 208, and/or via wireless signal inputs received via the wireless connection(s) from other connected devices, such as the server 206, among others.

The BCM 220 generally includes integration of sensors, vehicle performance indicators, and variable reactors associated with vehicle systems and may include processor-based power distribution circuitry that may control functions associated with the vehicle body such as lights, windows, security, camera(s), audio system(s), wipers, door locks and access control, various comfort controls, etc. The BCM 220 may also operate as a gateway for bus and network interfaces to interact with remote ECUs (not shown in FIG. 2).

The DAT controller 228 and/or the autonomous driving system 240 may provide Level-1 through Level-5 automated driving and driver assistance functionality that may include, for example, active parking assistance, vehicle backup assistance, and/or adaptive cruise control, among other features. The DAT controller 228 may also provide aspects of user and environmental inputs that are usable for user authentication.

In some embodiments, the automotive computer 208 may connect with an infotainment system 238 (or a vehicle Human-Machine Interface (HMI)). The infotainment system 238 may include a touchscreen interface portion and voice recognition features, biometric identification capabilities that may identify users based on facial recognition, voice recognition, fingerprint identification, or other biological identification means. In other aspects, the infotainment system 238 may be further configured to receive user instructions via the touchscreen interface portion and/or output or display notifications, navigation maps, etc. on the touchscreen interface portion. In some embodiments, the user device 112 may provide the HMI interface.

The computing system architecture of the automotive computer 208 and/or the VCU 210 may omit certain computing modules. It should be readily understood that the computing environment depicted in FIG. 2 is an example of a possible implementation according to the present disclosure, and thus, it should not be considered as limiting or exclusive.

In addition to the components noted above, the vehicle 102 may have numerous mechanical systems and sub-systems. A chassis or frame may form the backbone of the vehicle 102 and support the body and other components of the vehicle 102. The vehicle 102 may include an engine that converts fuel into mechanical power, propelling the vehicle forward. The engine includes various components such as the engine block, pistons, valves, and spark plugs. The vehicle 102 may also include a transmission system. The transmission system transfers the engine's power to the wheels. It includes the clutch, gearbox, driveshaft, and differentials, among other components. The transmission adjusts the power output to suit the vehicle's speed and load. The vehicle 102 may also include a suspension system. The suspension system absorbs shocks and maintains contact between the tires and the road, providing a smooth ride. It includes components such as springs, shock absorbers, and linkages. The vehicle 102 also includes a vehicle-stopping system that allows the driver to slow down or stop the vehicle 102. It includes components like pedals, master cylinders, lines, and pads or shoes. The vehicle 102 also includes a steering system that enables the driver to guide the car. The steering system includes components such as the steering wheel, steering column, rack and pinion, and tie rods. The vehicle 102 may also include an exhaust system that removes and filters the waste gases produced by the engine. It includes the exhaust manifold, catalytic converter, muffler, and tailpipe, among other components. The vehicle 102 also includes a cooling system that prevents the engine and/or battery from overheating. It includes components such as the radiator, water pump, thermostat, and coolant. The vehicle 102 also includes a cooling system that stores and supplies fuel to the engine. It includes the fuel tank, fuel pump, fuel filter, and fuel injectors. An electrical system of the vehicle 102 powers the car's electrical components. It may include the battery, alternator, starter motor, and wiring. The Heating, Ventilation, and Air Conditioning (HVAC) system controls the temperature inside the vehicle 102. It includes the heater core, blower motor, and air conditioning compressor. In some embodiments, the vehicle may be an electric vehicle (EV) or hybrid vehicle, and in either case, some of the aforementioned components would be replaced by an electric motor and a high-voltage battery. All of the mechanical components working together ensure that the vehicle 102 operates optimally.

Fogging occurs when there is a difference in temperature and humidity between the inside and outside of the vehicle. Moisture in the air inside the vehicle condenses on the cooler glass surfaces, forming fog. Different conditions, such as the humidity level inside the car, the outside weather, the type of HVAC system, and even the materials used in the interior, may all play a role in fog formation. Since fogging is caused by multiple variables, addressing just one factor (like air circulation) is often insufficient.

Most current anti-fogging systems rely on a few methods. For example, some vehicles use electrical heating elements embedded in the windshield or side windows. These are meant to increase the temperature of the glass slightly, preventing condensation. However, if the temperature difference between the inside and outside of the vehicle is too great, this method might not be enough. Other vehicles use air conditioning and defrosting systems to reduce humidity inside the car and maintain air circulation, but they are often slow to respond and can be ineffective if the system isn't running at full capacity or if the cabin is particularly humid (such as after rain or when passengers are breathing heavily). Some vehicles have glass with an anti-fog coating applied, which can reduce the condensation of moisture on the surface. However, these coatings can degrade over time and may not fully eliminate fogging. Many anti-fogging solutions are only applied to certain windows (typically the front windshield) or specific areas of the glass (such as a small section in front of the driver). Fog can still form on other windows, including the side windows, rear window, or rearview mirrors, and these areas may not have the same level of anti-fog protection.

Current anti-fogging systems are often passive (i.e., relying on temperature, air circulation, or coatings) rather than being proactive, which means they're limited in how they can deal with changing or extreme environmental conditions. For example, even with a dehumidifier running or air conditioning on, if the car is parked in a very cold location, fog can still form quickly when the interior warms up due to body heat or sunlight. In addition, many drivers may not use the anti-fogging features properly. For example, not running the air conditioning or defrost system at the right settings, or turning it off too early, can lead to fogging. Even if a vehicle is equipped with an automatic defogger, it may not activate under all conditions, or it may require manual intervention (such as adjusting the fan speed, temperature, or airflow direction). In some climates, fogging may be more prevalent due to specific environmental conditions—such as frequent temperature fluctuations, high humidity, or heavy rainfall—that the current systems are not designed to handle. During winter, especially, the rapid transition from cold to warm air inside the cabin can overwhelm standard anti-fog systems.

Embodiments of the present disclosure overcome all of the above issues by providing an intelligent and self-learning anti-fogging system that is capable of predicting the onset and severity of the fogging and taking the appropriate countermeasures at the right time to reduce or eliminate the fogging while also conserving energy used by the vehicle.

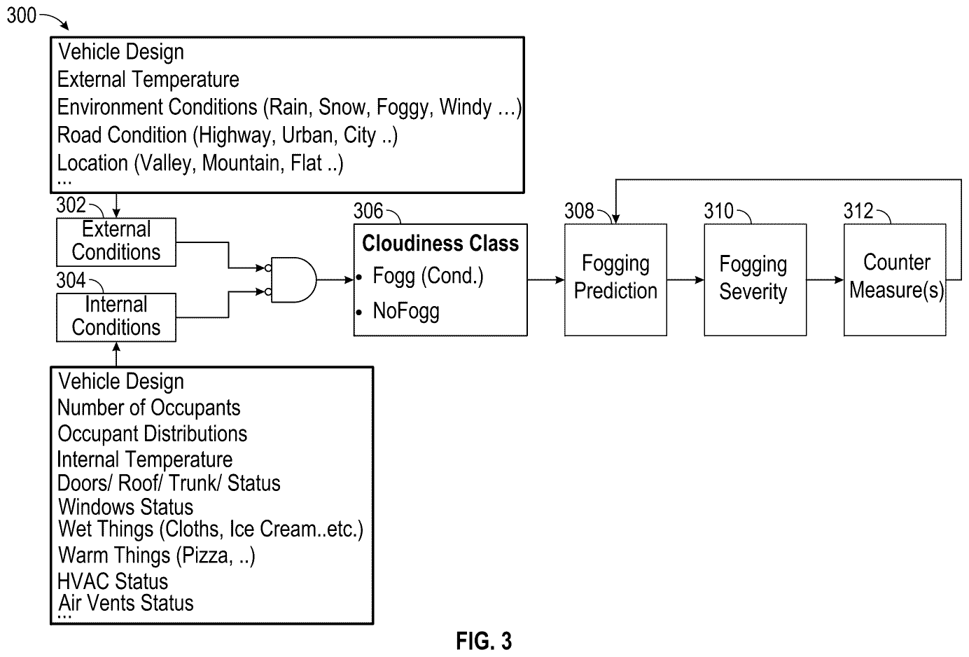

FIG. 3 illustrates a block diagram of a system 300 according to an embodiment of the present disclosure. The system 300 can be implemented solely in the vehicle 102, or in the server 104, or a combination of the vehicle 102 and the server 104. For example, the system 300 may be implemented within the automotive computer 208 and/or the vehicle control unit 210 of the vehicle 102 with a dedicated TCU/ECU. The system 300 uses existing sensors in the vehicle to determine the onset of fogging and the nature and severity of the fogging. The system 300 uses external environment data 302 of the environment in the vicinity of the vehicle 102 as one set of inputs to determine whether there is any probability of fogging occurring in the vehicle. The external environment data 302 can include information about the external/ambient temperature of an environment outside the vehicle. For example, a higher temperature may indicate less likelihood of fogging occurring compared to if the temperature is low outside the vehicle. The external environment data 302 may further include information about one or more external conditions, such as the presence of rain, snow, wind, etc. Each of these conditions may contribute differently to the formation of fog inside the vehicle. For example, a low external temperature with the presence of rain is likely to increase the chances of fogging compared to a sunny day with high ambient temperatures. The vehicle may determine the data about the external conditions from a rain sensor, a humidity sensor, or the like that are part of the vehicle sensory system 232. In an embodiment, the vehicle (e.g., via the automotive computer 208) may receive local weather report from an external server (e.g., server 104) indicating the current climate conditions in the vicinity of the vehicle.

In some embodiments, the external environment data 302 may also include road data, such as whether the road is flat, curvy, steep, etc. This data may be determined by the vehicle based on one or more inertial sensors of the vehicle, using radar, and/or using Lidar. For example, if the vehicle is traveling through a mountainous region, the road may often have a steep upward gradient and a steep downward gradient. This may be another factor that contributes to the formation of fogging inside the vehicle. In another embodiment, if the altitude of the vehicle changes substantially in a short period of time (e.g., the vehicle going downhill from a mountain top to a valley), it may be another factor that may contribute to occurrence of fogging inside the vehicle. Further, a current location (e.g., determined using a GPS or any other similar geo-spatial determination sensor of the vehicle) of the vehicle may also be used to determine whether the location may contribute to the fogging inside the vehicle. It is to be noted that a single external environment data may not be dispositive of whether fogging will or will not occur—it will often be a combination of these parameters that will be useful in predicting whether fogging will occur.

In addition to the external environment data 302, the system 300 may also receive vehicle internal data 304 and use the internal data 304 in conjunction with the external environment data 302 in order to determine the presence and/or probability of fogging inside the vehicle. The vehicle internal data 304 may include information about number of passengers in the vehicle, the location of each passenger within the vehicle, the internal temperature and humidity of the vehicle, the status of various doors and/or windows of the vehicle, the speed of the vehicle, presence of objects in the vehicle, the type and nature of those objects, status of the HVAC system, etc. For example, the probability of fogging increases with the number of people in the vehicle due to increased body temperature and breathing. Similarly, presence of hot/steaming objects (such as coffee, hot foods, etc.) and wet objects (such as wet clothes, snow, etc.) increase the probability of fog forming inside the vehicle. The system 300 takes into account both the external environment data 302 and the vehicle internal data 304 to determine whether the onset of fogging within the vehicle is impending (306). In an embodiment, this initial determination 306 may be coarse/binary, such as whether there is any likelihood of fogging occurring or not based on the current external data 302 and the vehicle internal data 304. For example, if it is sunny outside with a temperature of 80° F. and all the windows of the vehicle are in an open state, it can be inferred that there is very little or no possibility of fogging occurring in the vehicle. In an embodiment, the internal vehicle sensors such as a cabin camera, humidity sensor, temperature sensor, and other position sensors such as radar or Lidar can be used to determine the vehicle internal data 304. In addition, the status of the doors/windows, speed of vehicle, status of the HVAC system and other vehicle related parameters can be determined using various sensors that are located throughout the vehicle and are part of the sensory system 232 and via information transmitted over a CAN bus of the vehicle.

If based on the external environment data 302 and the vehicle internal data 304, it is inferred that fogging inside the vehicle is impending, the system 300 may then start to continually gather data from one or more sensors of the vehicle to monitor the external conditions and the internal vehicle conditions to determine a probability of fogging occurring and probable locations at which the fogging may occur (308). For example, the system 300 may determine whether the fogging may be more prominent on the front windscreen or the side windows. This will enable the vehicle to activate the correct countermeasure. Thereafter the system 300 may determine the severity of the fogging or the level of fogging (310). The severity of the fogging may be a function of several of the factors described above. In an embodiment, the severity of the fogging may be defined by a fogging function (FF) such that

$$FF = f ( external environment data , vehicle internal data ) \qquad ( 1 )$$

And the fogging severity (FS) can then be determined as

$$FS = f ( FF output , time , … ) \qquad ( 2 )$$

“FF output” represents the output of the fogging function represented in equation (1). The fogging severity may be indicative of how the fogging will proceed over time given the current external and internal conditions. In an embodiment, the fogging severity can be normalized on a scale of 1 to 10, with 1 being the least severe and 10 being the most severe. In an embodiment, the one or more of the severity levels 1 to 10 can also be designated as thresholds for triggering certain aspects of the system 300, as is described below in detail. The fogging severity can be quantified in terms of the rate of the fogging build-up, the extent of the fogging build-up, the locations at which the fogging is occurring, etc.

After the system 300 determines the fogging severity (310), the system can then activate and deploy one or more countermeasures (312). The countermeasures may include one or more of: operating the HVAC/defrosting system of the vehicle, opening one or more windows, etc. In an embodiment, the vehicle control unit 210 and/or the automotive computer 208 may perform the various actions that are part of the countermeasures. The system may also determine the settings and timing associated with the selected countermeasure(s). In an embodiment, the countermeasure may be defined using a defogging function (DF) such that

$$DF = f ( FS , external environment data , vehicle internal data time , … ) \qquad ( 3 )$$

In an embodiment, each of the severity levels may be mapped to one or more specific countermeasure(s) to be activated/deployed. This mapping may be done during the manufacturing of the vehicle and hard-coded into the memory (e.g., memory 204). In this instance, once the severity of the fogging is determined, the associated one or more countermeasures may be activated automatically. In some embodiments, after the countermeasures are activated, the system 300 may monitor the effectiveness of the countermeasure, and based on that, the mapping between the severity level and the countermeasures may be changed. For example, consider that the system 300 determines, based on the severity level, that the windscreen heater should be turned on at a certain setting to eliminate the fogging. However, after turning on the windscreen heater, the system 300 determines that the countermeasure is not very effective in defogging the windscreen. In this instance, the system may infer that the countermeasure was either not effective or the setting needs to be changed. The system 300 may then determine either a different countermeasure and/or a different setting for the countermeasure and associate that with the determined severity level. This new mapping may then be stored in the vehicle memory either as a new mapping, an alternate mapping, or the prior mapping may be overridden with the new mapping. In some embodiments, the user of the vehicle may change one or more settings of the countermeasures that are activated. For example, once a countermeasure is activated by the system 300, the user may determine that the countermeasure is not successfully mitigating the fogging. The user may then change one or more settings of the countermeasure (e.g., temperature setting of the HVAC) to a different setting than what the system 300 had initially determined. The system 300 can then note the change in the setting and update the mapping to include the new temperature setting for the countermeasure for the determined severity of the fogging. In this manner, the system 300 can be a self-learning system that continually updates the mapping based on user input/behavior.

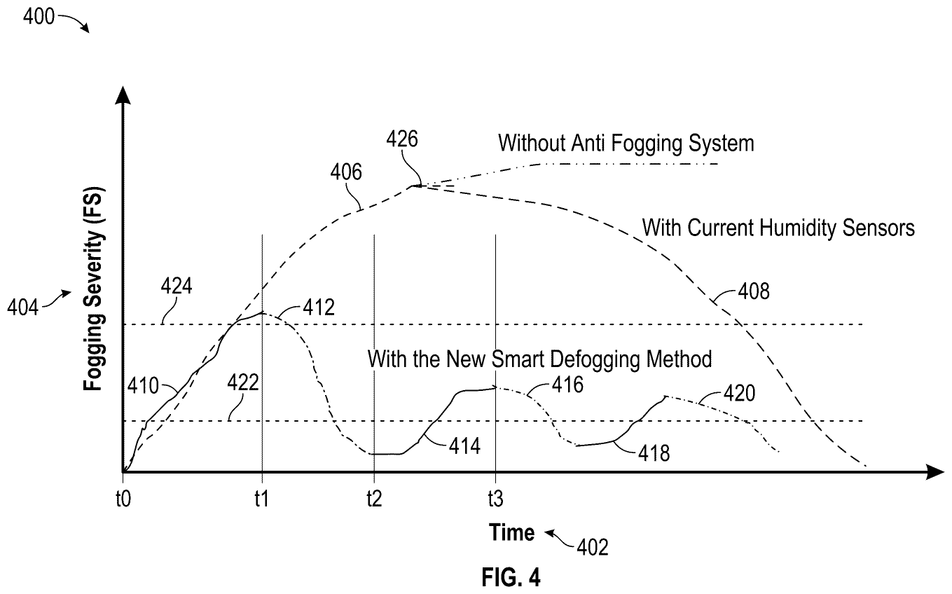

FIG. 4 depicts a graph 400 illustrating the effectiveness of the intelligent anti-fogging system according to an embodiment of the present disclosure. The x-axis of the graph 400 represents time 402, and the y-axis represents the fogging severity 404. As noted above, the fogging severity may be normalized on a linear or logarithmic scale and one or more severity levels may be designated as thresholds. The curve 406 of the graph 400 represents the operation of a vehicle that does not have any anti-fogging system. In this instance, the fogging starts to build up and continues building up until a certain time when it plateaus off or reaches a point of saturation. A combination of curves 406 and 408 represents the operation of a vehicle that has a traditional anti-fogging system based on the use of a humidity sensor attached to the windscreen of the vehicle. The humidity sensor is placed near the windscreen, often on or around the rearview mirror, or sometimes in the cabin air intake area. The humidity sensor detects the moisture level inside the cabin and determines when it is high enough to create a potential for fogging. When the humidity level reaches a set threshold (426), the vehicle then operates its HVAC system to manage the air circulation within the vehicle to reduce the fogging. However, in this instance, based on the accuracy and calibration of the humidity sensor, it may take a while for the HVAC system to start and/or mitigate the fogging. This causes a lot of energy to be wasted as the HVAC system may need longer to counter the fogging build-up. The humidity sensor also acts as a single point of malfunction in this system and if the humidity sensor malfunctions, the anti-fogging may not be activated at all.

In order to make the anti-fogging system more robust, the embodiments of the present disclosure eliminate the single point of malfunction and instead take into account several factors, as noted above, in order to determine when and which anti-fogging countermeasure is to be deployed. The curves 410, 412, 414, 416, 418, and 420 combined illustrate the operation of the intelligent anti-fogging system according to an embodiment of the present disclosure. The curves 410, 414, and 418 represent the fogging build-up inside the vehicle, while the curves 412, 416, and 420 represent the operation/effect of the respective anti-fogging countermeasure activated/deployed by the vehicle. At time t0, the system 300 may determine that fogging is impending based on the current environmental data and the vehicle internal data as described above. As the fogging starts to build up inside the vehicle, the system 300 continually monitors the various sensors and parameters described above to determine the severity of the fogging. As the severity of the fogging crosses the first threshold 422, the system 300 may run the fogging function at a higher rate to determine the cause of the fogging and also determine the appropriate countermeasure(s) to be deployed to mitigate the fogging. However, the system may not actually activate the countermeasure. The system keeps monitoring external data and the vehicle internal data to predict at what time the fogging severity will likely cross a second threshold 424. Once the system determines that the fogging severity has crossed the second threshold, it may activate the previously determined countermeasure at time t₁.

Once activated, the one or more countermeasures may start mitigating the fogging, as evidenced by the curve 412, and the fogging severity starts to decrease. Once the fogging severity decreases to a value at or below the first threshold 422, the countermeasures may be deactivated at time t₂. The external conditions and the internal conditions may still be such that fogging build up starts to occur again after time t₂. However, since the system is now continually monitoring the external data and the vehicle internal data, it does not wait until the fogging severity approaches or exceeds the second threshold 424 before it activates the countermeasures again. In the second instance, once the fogging severity exceeds the first threshold 422, the fogging countermeasures are reactivated at time t₃, as evidenced by the curve 416. In this manner the system continually calculates the fogging function (FF) and the fogging severity (FS) and activates and deactivates the fogging countermeasures in order to mitigate the fogging. As can be seen by operating the fogging countermeasures in short bursts and by accurately predicting the cause and severity of the fogging, the system can use less energy than the traditional systems. Also, since the system uses multiple data items to determine the onset of fogging and determining the fogging severity, it is much more robust than the traditional systems.

In an embodiment, the system determines the rate of change in the severity of the fogging prior to determining when to activate a particular countermeasure. The system can be programmed to activate a countermeasure if the rate of change of the fogging severity is above a threshold. The rate of change of the fogging severity (ΔFS) can be represented using the following equation.

$$Δ FS = FS ( {t}_{n} ) - FS ( {t}_{n} + Δ t ) \qquad ( 4 )$$

If the rate of change in the fogging severity is high, the system can infer that the fogging severity is likely to cross the second threshold 424 sooner compared to if the rate of change is low. This will inform the system 300 as to when the determined countermeasure is to be activated. In the example of FIG. 4, the determination of the rate of change of fogging severity (ΔFS) will determine the times t₁ and t₃ at which the system will activate the countermeasure. As can be seen in FIG. 4, the anti-fogging countermeasure, according to the embodiment of the present disclosure, is deployed in shorter cycles, thereby saving energy used by the vehicle. In an embodiment, a TCU/ECU of the vehicle control unit 210 or the module 245 within the memory 204 of the automotive computer 208 may include instructions that may be executed by the processor 202 to execute the fogging function, the defogging function, and the fogging severity determination calculation discussed above.

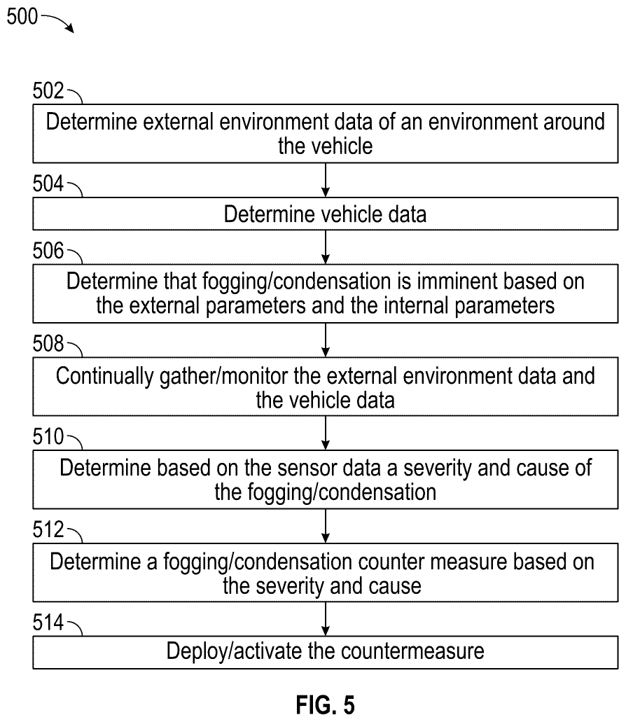

FIG. 5 illustrates a flow chart of a process 500 for mitigating the effects of fogging inside a vehicle according to an embodiment of the present disclosure. Process 500 can be performed solely by the vehicle 102 or the vehicle 102 in conjunction with the remote server 104. In an embodiment, the process 500 may be performed by the automotive computer 208 and/or the vehicle control unit 210 of the vehicle 102.

At step 502, the vehicle may determine external environmental data/conditions of the environment in the vicinity of the vehicle (e.g., using one or more sensors of the vehicle and/or receiving the environmental data from one or more external sources). These external environmental conditions may include the presence of rain, snow, fog, smog, ambient temperature, ambient humidity, location, road condition, etc. as explained above in connection with FIG. 3. At step 504, the vehicle may determine one or more vehicle parameters such as number of occupants, cabin temperature, cabin pressure, humidity, number and types of objects in the vehicle, etc. as explained above in connection with FIG. 3. The vehicle parameters/data may be obtained using one or more sensors of the vehicle such as camera, Radar, Lidar, infrared sensor, and the like. Based on the external environment data and the vehicle data, the vehicle may then determine whether fogging of one or more surfaces of the vehicle is impending, at step 506. For example, if the humidity inside the vehicle is higher than the humidity outside the vehicle and/or the ambient temperature of the environment is lower than the temperature inside the vehicle, the vehicle may infer that there is a high likelihood of fogging occurring. Once the vehicle determines that the likelihood of fogging occurring is high or that fogging is impending, the vehicle may run the fogging function (FF) described above, at step 508. As part of running the fogging function/algorithm, the vehicle may continually gather/monitor the external environment data and the vehicle data and process that data using the fogging function to determine the severity of the fogging, at step 510. In addition, the vehicle may also determine one or more locations within the vehicle where the fogging is most likely to occur. For example, if the temperature in the vehicle is higher than the external ambient temperature and only the driver is present in the vehicle, the vehicle may infer that fogging is more likely to occur on the windscreen portion closer to the driver and the driver-side window compared to the back window.

Once the vehicle determines the severity of the fogging and location of where the fogging is more/most likely to occur, the vehicle can then determine the appropriate anti-fogging or defogging countermeasure that needs to be used, at step 512. Continuing our above example, if the vehicle determines that fogging is more likely to occur on the windscreen and driver-side window, the vehicle may determine that turning on the HVAC system at a specific temperature setting and directing the airflow to one or more vents near the portion of the windscreen and the driver-side window will be most effective in countering the fogging. Thereafter, the vehicle may deploy the determined countermeasure at step 514. In this manner, the vehicle can tailor the countermeasure more effectively and refrain from simply directing air from the HVAC system to all portions of the vehicle. In some embodiments, the vehicle may direct a first portion of air to the windscreen and the driver-side window and second portion of air to the rest of the cabin, wherein the second portion is smaller than the first portion.

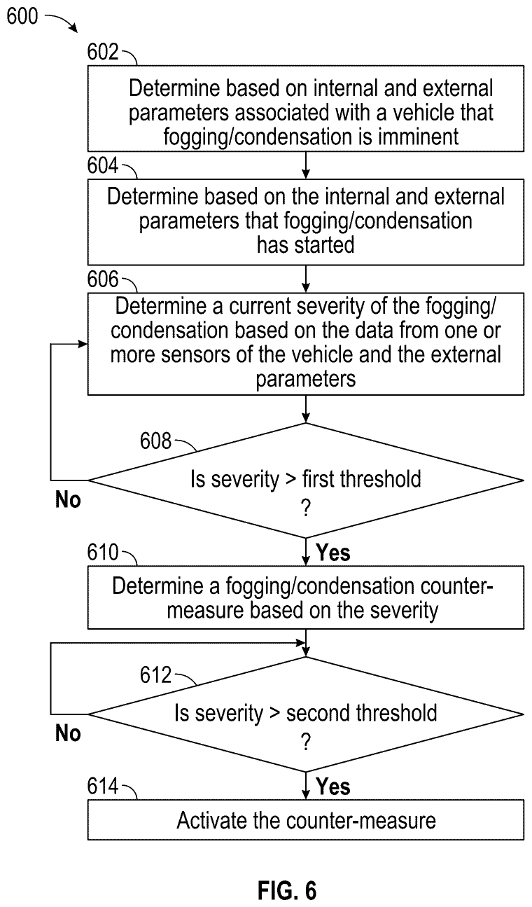

FIG. 6 illustrates a flow chart for a process 600 for providing an intelligent defogging feature according to an embodiment of the present disclosure. Process 600 can be performed solely by the vehicle 102 or the vehicle 102 in conjunction with the remote server 104. In an embodiment, the process 600 may be performed by the automotive computer 208 and/or the vehicle control unit 210 of the vehicle 102.

At step 602, the vehicle may determine that fogging of one or more surfaces of the vehicle is impending based on one or more external environmental factors and/or vehicle data. The external environmental factors and the vehicle data are explained above in connection with FIG. 3. Thereafter, at step 604, the vehicle may determine based on one or more sensors of the vehicle that fogging has started. For example, the vehicle may use a humidity sensor along with an internal camera of the vehicle to determine that one or more surfaces of the vehicle are experiencing fogging. Thereafter, at step 606, the vehicle may determine a severity associated with the fogging using the vehicle sensor data and the external environment data. In an embodiment, the vehicle may use the fogging severity function described above to determine the severity of the fogging. At step 608, the vehicle may determine whether the severity of the fogging is above or below a first threshold. The first threshold may be set by the manufacturer of the vehicle or by the user of the vehicle. In an embodiment, the first threshold may represent a level of fogging that does not interfere with the operation of the vehicle. For example, the first threshold may represent minor fogging that does not impede the driver's view of the road.

If at step 608, it is determined that the severity of the fogging is below or at the first threshold, the process 600 may return to the step 606 and continue monitoring the severity of the fogging. At this time, the vehicle may not deploy any ant-fogging countermeasure, and vehicle may continue monitoring and determining the severity of the fogging. If at step 608, it is determined that the severity of fogging is above the first threshold, the vehicle may start running the fogging severity algorithm/function at a higher rate in anticipation that the fogging severity will rise further. In other embodiments, the vehicle may determine the rate of change in the severity of the fogging over a time period to determine whether the fogging is increasing rapidly or slowly. The vehicle may also determine one or more countermeasures that are to be deployed based on the severity and the nature of the fogging (step 610). Even at this time, the vehicle may not actually deploy any anti-fogging countermeasure.

At step 612, the vehicle may determine whether the severity of the fogging is at or above a second threshold. The second threshold may represent a level of fogging that impedes the normal operation of the vehicle. If at step 612, the vehicle determines that the severity of the fogging is below the second threshold, the vehicle may keep monitoring/determining the severity of the fogging and enter a waiting mode. If at step 612 it is determined that the severity of the fogging is at or above the second threshold, the vehicle may then activate/deploy the one or more countermeasures determined in the prior step, at step 614.

In some embodiments, the vehicle may determine the effectiveness of the deployed countermeasure in reducing or eliminating the fogging (e.g., using the one or more sensors of the vehicle sensing system 232). If the vehicle determines that the countermeasure is not effective in eliminating or reducing the fogging, the vehicle may change one or more settings associated with the countermeasure. For example, the vehicle may change a temperature setting of the HVAC system. In this manner, the vehicle may continually monitor the effectiveness of the countermeasure and adjust the settings accordingly. In other embodiments, the vehicle may deploy an additional countermeasure if it determines that the currently deployed countermeasure is not effective in reducing or eliminating the fogging.

In some embodiments, in addition to the data collected by the vehicle, the vehicle may also receive data from other nearby vehicles using vehicle-to-vehicle (V2V)communication or data from one or more external sources using vehicle-to-infrastructure (V2X) communications in order to determine the onset and/or severity of the fogging. In other embodiments, the vehicle may also receive data from one or more IoT sensors associated with the vehicle or accessible by the vehicle and use that data to determine the onset and/or severity of the fogging. In other embodiments, the server 104 may receive fogging-related data, as explained above, from a plurality of vehicles having different shapes, sizes, configurations, etc., and generate a machine-learning model to predict the onset and severity of fogging. This machine-learning model may then be deployed in the vehicle and used to determine/predict the likelihood of fogging, the severity of the fogging, and the appropriate countermeasure to be deployed.

FIG. 7 depicts a block diagram of an example control server 700 (e.g., control server 104 of FIG. 1) upon which any of one or more techniques (e.g., methods) may be performed or which may perform the methods described above in conjunction with the vehicle 102, in accordance with one or more example embodiments of the present disclosure. In other embodiments, the server 700 may operate as a standalone device or may be connected (e.g., networked) to other servers. In a networked deployment, the server 700 may operate in the capacity of a server machine, a client machine, or both in server-client network environments. In an example, the server 700 may act as a peer server in peer-to-peer (P2P) (or other distributed) network environments. The server 700 may be a personal computer (PC), a tablet PC, a set-top box (STB), a personal digital assistant (PDA), a mobile telephone, a smart key fob, a wearable computer device, a web appliance, a network router, a switch or bridge, or any machine capable of executing instructions (sequential or otherwise) that specify actions to be taken by that server, such as a base station. Further, while only a single server is illustrated, the term “server” shall also be taken to include any collection of servers that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer-readable medium containing instructions where the instructions configure the execution units to carry out a specific task when in operation. The configuring may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The server (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The server 700 may further include a graphics display device 710, an alphanumeric input device 712 (e.g., a keyboard), and a user interface (UI) navigation device 714 (e.g., a mouse). In an example, the graphics display device 710, alphanumeric input device 712, and UI navigation device 714 may be a touch screen display. The server 700 may additionally include a storage device (i.e., drive unit) 716, a network interface device/transceiver 720 coupled to antenna(s), and one or more sensors 728, such as a global positioning system (GPS) sensor, a compass, an accelerometer, or another sensor. The server 700 may include an output controller 734, such as a serial (e.g., universal serial bus (USB)), parallel, or other wired or wireless (e.g., infrared (IR)), near field communication (NFC), etc. connection to communicate with or control one or more peripheral devices (e.g., a printer, a card reader, etc.).

The storage device 716 may include a machine-readable medium 722 on which is stored one or more sets of data structures or instructions (e.g., software) embodying or utilized by any one or more of the techniques or functions described herein. The instructions may also reside, completely or at least partially, within the main memory 704, within the static memory 706, or within the hardware processor 702 during execution thereof by the server 700. In an example, one or any combination of the hardware processor 702, the main memory 704, the static memory 706, or the storage device 716 may constitute machine-readable media.

While the machine-readable medium 722 is illustrated as a single medium, the term “machine-readable medium” may include a single medium or multiple media (e.g., a centralized or distributed database, and/or associated caches and servers) configured to store the one or more instructions.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read-only memory (ROM) random access memory (RAM), magnetic disk storage media, optical storage media; a flash memory, etc.

The term “machine-readable medium” may include any medium that is capable of storing, encoding, or carrying instructions for execution by the server 700 and that causes the server 700 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions may further be transmitted or received over a communications network using a transmission medium via the network interface device/transceiver 720 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 720 may include one or more physical jacks (e.g., Ethernet, coaxial, or phone jacks) or one or more antennas to connect to the communications network. In an example, the network interface device/transceiver 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the server 700 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

It is to be noted that the vehicle implements and/or performs operations, as described here in the present disclosure, in accordance with the owner manual and safety guidelines. In addition, any action taken by the vehicle owner/driver based on recommendations or notifications provided by the vehicle should comply with all the rules specific to the location and operation of the vehicle (e.g., Federal, state, country, city, etc.). The recommendations or notifications, as provided by the vehicle, should be treated as suggestions and only followed according to any rules specific to the location and operation of the vehicle. In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more hardware, software, firmware, digital components, or analog components. For example, one or more application-specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

It should also be understood that the word “example” as used herein, is intended to be non-exclusionary and non-limiting in nature. More particularly, the word “example” as used herein, indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices, such as those listed above, and stored on a computer-readable medium.

With regard to the processes, systems, methods, heuristics, etc., described herein, it should be understood that, although the steps of such processes, etc., have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
determining, by a vehicle, one or more external conditions associated with an external environment of the vehicle;
determining, by the vehicle, vehicle internal data;
determining, by the vehicle and based on the one or more external conditions and the vehicle internal data, that fogging is impending;
executing, by the vehicle, a first function to determine a severity of the fogging;
determining, by the vehicle, that the severity of the fogging is above a threshold; and
deploying, by the vehicle and based on the severity of the fogging being above the threshold, one or more countermeasures.

2. The method of claim 1, wherein the one or more external conditions include one or more of:
ambient temperature data;
ambient humidity data;
presence of rain, snow, or fog;
road condition data;
location information; or
altitude data.

3. The method of claim 1, wherein the vehicle internal data includes one or more of:
a number of occupants in the vehicle;
location of the occupants of the vehicle within the vehicle;
humidity data within the vehicle;
temperature data within the vehicle;
pressure data within the vehicle;
configuration data of the vehicle; or
status of one or more windows or doors of the vehicle.

4. The method of claim 1, wherein executing the first function further comprises:
processing data associated with the one or more external conditions; and
processing the vehicle internal data.

5. The method of claim 1, wherein the threshold is a first threshold, the method further comprising:
determining, by the vehicle, that the severity of the fogging is above the first threshold but below a second threshold, wherein the second threshold is higher than the first threshold; and
determining, by the vehicle and based on the severity of the fogging being below the second threshold, the one or more countermeasures.

6. The method of claim 1, further comprising:
determining, by the vehicle, an effectiveness of the one or more countermeasures;
adjusting, by the vehicle and based on the effectiveness, one or more settings associated with the one or more countermeasures.

7. The method of claim 1, wherein the one or more countermeasures include:
operating a heating, ventilation, and air conditioning (HVAC) system of the vehicle;
operating a heating element associated with one or more surfaces of the vehicle; or
opening one or more windows of the vehicle.

8. The method of claim 1, further comprising:
determining, by the vehicle and based on the first function and the vehicle internal data, a location at which the fogging is most likely to occur.

9. A method comprising:
determining first data associated with one or more external conditions associated with an environment in a vicinity of a vehicle;
determining second data associated with the vehicle;
determining, based on the first data and the second data, that fogging of one or more surfaces of the vehicle is impending;
determining, using a first function executing at a first rate, a first severity of the fogging;
determining that the first severity of the fogging is above a first threshold;
executing the first function at a second rate higher than the first rate;
determining, using the first function executing at the second rate, a second severity of the fogging;
determining that the second severity is at or above a second threshold; and
activating a countermeasure based on the second severity being at or above the second threshold.

10. The method of claim 9, wherein the second threshold is higher than the first threshold.

11. The method of claim 9, further comprising:
determining an effectiveness of the countermeasure; and
adjusting one or more settings associated with the countermeasure based on the effectiveness of the countermeasure.

12. The method of claim 9, wherein activating the countermeasure includes one or more of:
operating a heating, ventilation, and air conditioning system of the vehicle;
operating a heating element associated with the one or more surfaces; or
opening one or more windows of the vehicle.

13. The method of claim 9, wherein the first data includes one or more of:
data indicative of rain in the environment;
data indicative of snow in the environment;
ambient temperature data associated with the environment;
ambient humidity data associated with the environment;
road condition data associated with the environment; or
altitude data associated with the environment.

14. The method of claim 9, wherein the second data includes one or more of:
a number of occupants in the vehicle;
a location of each occupant of the vehicle;
temperature data associated with a vehicle passenger cabin;
a number of objects and a type of objects present in the vehicle;
humidity data associated with the vehicle passenger cabin; or
status of one or more doors or windows of the vehicle.

15. A vehicle comprising:
one or more processors;
one or more sensors coupled to the one or more processors; and
a memory device coupled to the one or more processors and storing instructions which, when executed by the one or more processors, cause the one or more processors to:
determine first data associated with one or more external conditions associated with an environment in a vicinity of the vehicle;
determine second data associated with the vehicle;
determine, based on the first data and the second data, that the fogging of one or more surfaces of the vehicle is impending;
determine, using a first function executing at a first rate, a first severity of the fogging;
determine that the first severity of the fogging is above a first threshold;
execute the first function at a second rate higher than the first rate;
determine, using the first function executing at the second rate, a second severity of the fogging;
determine that the second severity is at or above a second threshold; and
activate a countermeasure based on the second severity being at or above the second threshold.

16. The vehicle of claim 15, wherein the second data includes one or more of:
a number of occupants in the vehicle;
a location of each occupant of the vehicle;
temperature data associated with a vehicle passenger cabin;
a number of objects and a type of objects present in the vehicle;
humidity data associated with the vehicle passenger cabin; or
status of one or more doors or windows of the vehicle.

17. The vehicle of claim 15, wherein the one or processors are operable to execute the instructions to:
determine an effectiveness of the countermeasure; and
adjust one or more settings associated with the countermeasure based on the effectiveness of the countermeasure.

18. The vehicle of claim 15, wherein to activate the countermeasure, the one or processors are operable to execute the instructions to:
operate a heating, ventilation, and air conditioning (HVAC) system of the vehicle;
operate a heating element associated with the one or more surfaces; or
open one or more windows of the vehicle.

19. The vehicle of claim 15, wherein the second data includes one or more of:
a number of occupants in the vehicle;
a location of each occupant of the vehicle;
temperature data associated with a vehicle passenger cabin;
a number of objects and a type of objects present in the vehicle;
humidity data associated with the vehicle passenger cabin; or
status of one or more doors or windows of the vehicle.

20. The vehicle of claim 15, wherein the second threshold is higher than the first threshold.
